(19) United States
(12) Patent Application Publication
(10) Pub. No.: US 2026/0346466 A1
(43) Pub. Date: Nov. 5, 2026

(54) METHOD FOR AUTOMATICALLY MAPPING THE RADIATION IN A PORTION OF A BUILDING AND A ROBOT VEHICLE

(71) Applicant: FRAMATOME GMBH, ERLANGEN (DE)

(72) Inventors: Sebastian KOHN, NÜRNBERG (DE); Oliver SOMMER, ERLANGEN (DE); Adele WEBER, ERLANGEN (DE); Naeel MUHAMAD ALI, NÜRNBERG (DE); Frank QUERFURTH, TUCHENBACH (DE)

(21) Appl. No.: 19/476,422

(22) PCT Filed: Apr. 19, 2023
(86) PCT No.: PCT/EP2023/060171

§ 371 Date: Oct. 17, 2025

(51) Int. Cl. B25J 11/00; B25J 9/16; B25J 13/08; G01T 1/169

(52) U.S. Cl. CPC B25J 11/0075; B25J 9/1697; B25J 13/089; G01T 1/169

(57) ABSTRACT

A method for automatically mapping the radiation in a portion of a building and/or of a portion of a transport object using a robot vehicle, the portion of the building and/or of the transport object including a plurality of surfaces., The method includes acquiring a 3D map of a portion of a building and/or object; physically marking, by the robot vehicle, the border of each sector of each segment of the 3D map with paint on the surface and mapping the radiation for one or more sectors, by scanning, by the robot vehicle, with a radiation sensor each sector to measure the radiation within that sector. The method further includes rendering 3D images based on the 3D Map, sending the images to a virtual reality system, detecting commands from a commanding device of the virtual reality system, transmitting the commands to the robot vehicle; and operating the robot vehicle in response.

The present disclosure concerns a method for automatically mapping the radiation in a portion of a building using a robot vehicle.

Further, the present disclosure relates to a robot vehicle for automatically mapping the radiation in a portion of a building.

### BACKGROUND

When nuclear power plants are decommissioned, the radiation of the walls and the equipment must be measured and mapped in all rooms. Sometimes the walls and equipment must even be measured several times. This has been previously done by humans. However, the risk of exposure to radiation and contamination may be elevated for such a task.

CN 110231642 A discloses a method of constructing a radiation field map. For that purpose, a video image of the radiation is taken. Further, a positioning mapping is performed. This information is fused to obtain a radiation field map.

U.S. Pat. No. 5,936,240 discloses mobile robotic system that conducts radiological surveys to map alpha, beta, and gamma radiation on surfaces. For that purpose, the robot includes a LIDAR system for the navigation. The radiation data is gathered and mapped in order to provide a real-time printing of maps of floor contamination.

EP 542 561 A1 discloses a radiation mapping system using a mobile robot vehicle. The radiation mapping system includes a radiation detector system, which is attached to an L shaped structure, which can be moved using a motor.

### SUMMARY

An object of the present disclosure is to improve the existing system, and in particular, to provide a system and a method, which can provide reliable results and which can be verified.

According to one aspect, a method for automatically mapping the radiation in a portion of a building and/or of a portion of a transport object using a robot vehicle, the portion of the building and/or of the transport object comprising a plurality of surfaces, the method comprising:
acquiring a 3D map of a portion of a building and/or of a portion of a transport object, wherein the 3D map comprises a plurality of segments, each representing a surface of the building and/or of the transport object;
applying to each segment a plurality sectors forming a grid of sectors, each sector having a border;
physically marking, by the robot vehicle, at least a portion of the border of each sector with paint on the corresponding surface; and
mapping the radiation for one or more sectors, by scanning, by the robot vehicle, with a radiation sensor each sector of the one or more sectors, to measure the radioactive radiation within that sector, wherein the method further comprises:
rendering at least one 3D image based on at least one portion of the 3D Map;
sending the at least one rendered 3D image to at least one screen of a virtual reality system being arranged remotely from the robot vehicle;
detecting commands from a commanding device of the virtual reality system; transmitting the commands to the robot vehicle; and
operating the robot vehicle in response to the commands.

Further embodiments may relate to one or more of the following features, which may be combined in any technical feasible combination:
the at least one screen is in a goggle or projected in a goggle;
the robot vehicle comprises the radiation sensor for measuring radioactive radiation and a plurality of cameras and/or second sensors, the one or more second sensors are adapted to provide data that enables to determine the position of the robot vehicle within the building and/or to determining the distance to objects within the building, wherein acquiring a 3D map of a portion of a building comprises: acquiring data from the plurality of cameras and/or second sensors; generating from the acquired data the 3D map of the portion of the building;
images acquired by the at least one camera is integrated in the 3D map, in particular by coloring segments of the 3D map and/or each point in a point cloud used for generating the segments using the visible light information or color information from the images acquired by the at least one camera;
the robot vehicle comprises a manipulator arm having a proximal end fixed to a main body of the robot vehicle and a distal end, wherein a sensor support device is fixed to the distal end of the manipulator arm, the radiation sensor for measuring radioactive radiation being fixed to the sensor support device;
the method further comprising operating the manipulator arm of the robot vehicle in response to the commands;
the plurality of cameras and/or second sensors are arranged on the main body and/or the sensor support device;
the method further comprising acquiring by the robot vehicle at least one image of the surface, determining the borders of the sectors on the surface based on the acquired image, and moving the robot vehicle and/or the manipulator arm of the robot vehicle based on the determined borders during scanning with the radiation sensor;
the method further comprising for one or more sectors, scanning, by the robot vehicle, with a radiation sensor each sector, to measure the radioactive radiation within that sector;
the radiation for one or more sectors is automatically mapped;
the method further comprising marking physically with paint a point on the surface within each scanned sector with the highest measured radiation within the respective sector;
the method further comprising digitally marking the grid of sectors in the 3D map;
the method further comprising determining whether the radiation exceeds a predetermined radiation dose, and in case the radiation exceeds a predetermined radiation dose, marking physically the sector on the surface by applying paint thereon.
each sector is marked, by the robot vehicle, on the surface with an identifier using paint;
the method further comprising displaying the measured radioactive radiation on the 3D map;
the method further comprising taking, by the robot vehicle, a sample of the surface in at least one sector, in particular at the point with the highest measured radiation within the at least one sector;
the physically marking is performed by spraying paint on the surface.

According to another aspect, a system a robot vehicle for automatically mapping the radiation in a portion of a building and/or of a portion of a transport object is provided, the portion of the building and/or the transport object comprising a plurality of surfaces, the robot vehicle comprising:
a main body;
a movement apparatus adapted to move the robot vehicle over a rough surface comprising steps
a radiation sensor for measuring radioactive radiation;
a spray nozzle;
wherein the system further comprises a remote controller and a commanding device arranged remotely from the robot vehicle, wherein the remote controller and/or the robot vehicle is adapted to acquire a 3D map of a portion of the building, wherein the 3D map comprises a plurality of segments, each representing a surface of the building and/or the transport object;
wherein the system is adapted to apply to each segment a plurality sectors forming a grid of sectors, each sector having a border;
wherein the robot vehicle is adapted to physically mark at least a portion of the border of each sector with paint on the corresponding surface;
wherein the remote controller is adapted to render a 3D image based on a portion of the 3D map to be displayed on at least one screen and to send the rendered 3D image to the at least one screen;
wherein the commanding device adapted to send commands to the remote controller, wherein the remote controller is adapted to transmit the commands to the robot vehicle, wherein the robot vehicle is adapted to operate in response to the commands.

Further embodiments may relate to one or more of the following features, which may be combined in any technical feasible combination:
the robot vehicle further comprises a plurality of cameras and/or second sensors, the one or more second sensors are adapted to provide data that enables to determine the position of the robot vehicle within the building and/or to determining the distance to objects within the building, wherein the remote controller and/or an internal controller of the robot vehicle is adapted to acquire the data from the plurality of cameras and/or second sensors and to generate a 3D map of a portion of a building based on the acquired data;
the robot vehicle further comprises at least one manipulator arm, having a plurality of segments, the segments being connected to an adjacent segment by a rotatable joint having one or more joint motors, the manipulator arm having a proximal end and a distal end, wherein a sensor support device is fixed to the distal end of the manipulator arm, the radiation sensor for measuring radioactive radiation and the spray nozzle being fixed to the sensor support device;
the plurality of cameras and/or second sensors are arranged on the main body and/or the sensor support device;
the robot vehicle is adapted to move the manipulator arm in response to the commands;
the commanding device is a handheld device or an operator;
the movement apparatus has at least two legs and/or wheels;
the distal end of the manipulator arm has six or more degrees of freedom;
the spray nozzle is in fluid connection with a pressurized paint tank;
the robot vehicle comprises at least one distance control device which is adapted to control the distance of between the radiation sensor and a surface to be measured, in particular of the building and/the transport object;
the distance control device comprises at least three stoppers being in a fixed relationship with respect to the radiation sensor and/or the spray nozzle, the distal ends of the at least three stoppers spanning a plane, which is in a predetermined distance to the radiation sensor, wherein, in particular, the sensor measurement direction is perpendicular to the plane, wherein in particular each stopper has a roller or a caster wheel at its distal end;
the distance control device comprises at least one distance sensor at the sensor support device and/or at least one internal controller adapted to estimate the distance between the radiation sensor and the surface based on data of the one or more joint motors and/or sensors of the manipulator arm in connection with a determined distance between the robot vehicle and the surface using the plurality of cameras and/or sensors; and/or
the robot vehicle is adapted to acquire at least one image of a surface by the plurality of cameras and/or sensors, to determine the borders of sectors on the surface based on the acquired image, and to move the robot vehicle and/or the manipulator arm of the robot vehicle based on the determined borders during a scanning with the radiation sensor.

Further advantages, features, aspects and details are evident from the dependent claims, the description and the drawings.

### BRIEF DESCRIPTION OF THE DRAWINGS

The accompanying drawings relate to embodiments of the present disclosure and are described in the following:

FIG. 1 shows a robot vehicle according to an embodiment;

FIG. 2 shows schematically a system according to an embodiment;

FIG. 3 shows a manipulator arm of the robot vehicle;

FIG. 4 shows schematically a distal end of the manipulator arm of the robot vehicle;

FIG. 5 shows a front view of the distal end of the manipulator arm of the robot vehicle;

FIG. 6 shows schematically a marking system used by the robot vehicle;

FIG. 7 shows schematically a created virtual map;

FIG. 8 shows a wall and floor with an applied grid;

FIG. 9 shows a flow chart of a method according to an embodiment;

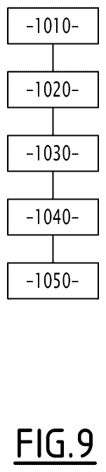

FIG. 10 shows schematically a system for mapping automatically the radiation in a portion of a building with the robot vehicle;

FIG. 11 shows schematically a virtual reality system; and

FIG. 12 shows schematically a flow chart of an embodiment of a method according to the present disclosure.

### DETAILED DESCRIPTION

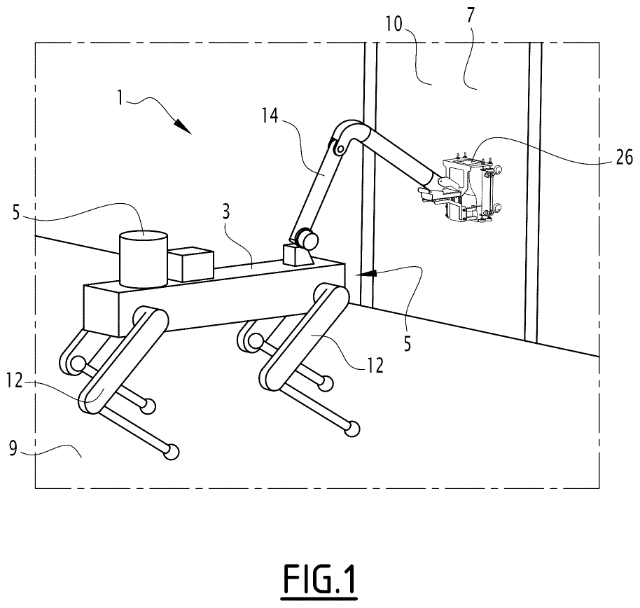

FIG. 1 shows a robot vehicle 1. The robot vehicle 1 comprises a main body 3. On the main body 3 a plurality of cameras and/or sensors 5 are arranged. The cameras and sensors 5 are used for acquiring a 3D map of a portion of a building 7. For example, the plurality of cameras and/or sensors 5 are scanning the environment of the robot vehicle 1.

The portion of the building 7 comprises building surfaces 9, 10, in particular substantially flat building surfaces. The building surfaces 9, 10 may comprise a floor 9 and/or one or more walls 10.

The plurality of cameras and/or sensors 5 are arranged on the main body 3 such that they can acquire the near and far environment of the robot vehicle 1.

In some embodiments, the building 7 is a building of a nuclear power plant.

In some embodiments, instead of or additionally to a portion of the building 7, a transport object (not shown) is mapped by the robot vehicle in order to acquire a 3D map. A transport object is an object, in which contaminated material can be transported. For example, a transport object has transport volume of several cubic meters, for example at least 15 cubic meters, in particular at least 30 cubic meters. An example of a transport object is a 20 feet container. For example, a transport object has a plurality of substantially flat surfaces. Thus, the following description does not only apply to a portion of a building and the respective to building surfaces but also to the transport object and the respective surfaces of the transport object.

The plurality of cameras and/or sensors 5 are used for determining the position of the robot vehicle within a building 7 and/or for determining the distance to objects within the building 7 or within or around the transport object. According to embodiments, the cameras and/or sensors 5 are adapted to provide data that enables the determination of the position of the robot vehicle 1, in particular within the building 7, for example relative to building surfaces, surfaces of the transport object or objects in the building 7.

For example, at least one sensor of the plurality of cameras and/or sensors 5 is a LIDAR (Light amplification by Stimulated Emission of Radiation detection and ranging) sensor. The output of the LIDAR sensor can be used to calculate the distance between itself (the robot vehicle 1) and surrounding building surfaces 9, 10 in particular the walls 10 and/or a surface of the transport object. In some embodiments, other cameras of the plurality of cameras and/or sensors 5 are taking pictures of the near environment of the robot vehicle 1. The cameras may be also used to determine a distance, for example by taking also into account the distance moved by the robot vehicle 1.

Further, the robot vehicle 1 includes a movement apparatus 12. The movement apparatus 12 is provided for moving the robot vehicle through the building 7 and/or the transport object. The movement apparatus 12 is adapted to move the robot vehicle 1 about an area, which comprises steps. The steps may have a height of at least 10 cm, in particular of at least 15 cm.

The movement apparatus 12 has at least two legs and/or wheels. In the embodiment shown in FIG. 1, the movement apparatus has four legs. In some embodiments, each leg may have at least one wheel, in particular two wheels. The wheels may be propelled.

However, also other forms are possible. For example, the movement apparatus 12 may be provided with a front and back leg, with respectively two wheels.

The movement apparatus may enable the robot vehicle 1 to move autonomously through the portion of the building 7. In some embodiments, the movement of the robot vehicle 1 is controlled using a remote controller.

Further, a manipulator arm 14 is connected to the main body 3. The manipulator arm 14 includes a plurality of segments, which are in particular oblong. Each segment is connected to a neighboring segment by a rotatable joint having one or more joint motors. Each segment may have also at least one end, which is rotatable about the longitudinal axis of the respective segment. Further, the manipulator arm 14 may include one or more sensors for detecting the movement and/or the positioning of the different segments, in particular to each other.

The manipulator arm 14 having a proximal end 16 and a distal end 18. The proximal end 16 being fixed rotatably to the main body 3, in particular about an axis, which is perpendicular to the upper surface of main body 3. For example, the proximal end can be rotated by −150 degrees to 180 degrees with respect to the main body.

In other words, the manipulator arm 14 can turn its distal end 18 in six or more degrees of freedom.

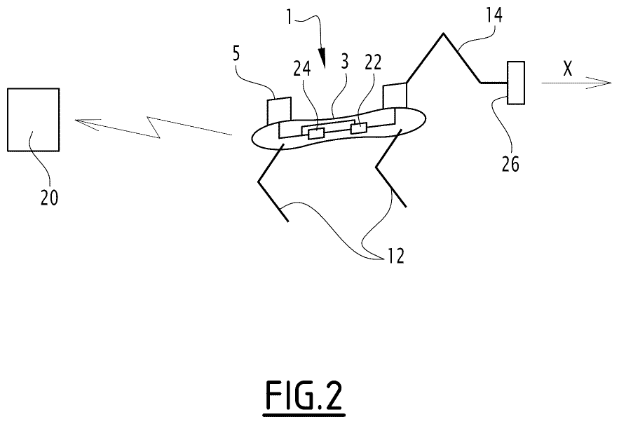

FIG. 2 shows a system comprising a remote controller 20 and the robot vehicle 1. The robot vehicle 1 comprises at least one internal controller 22 and a wireless communication device 24. The at least one internal controller 22 is adapted to control the movement of the robot vehicle 1 and of the manipulator arm 14.

The remote controller 20 is for example a computer with a wireless communication device. The remote controller 20 may comprise a display for displaying the environment of the robot vehicle 1. For example, the at least one internal controller 22 is adapted to transmit the information acquired by the plurality of cameras and/or sensors 5 to the remote controller 20.

Further, the at least one internal controller 22 and/or the remote controller 20 are adapted to create a 3D (3 dimensional) map of at least a portion of the building 7 and/or the transport object using the data provided by the plurality of cameras and/or sensors 5 and in particular of the movement apparatus 12.

For example, the portion of the building 7 (or the complete building 7) and/or the transport object is scanned using the plurality of cameras and/or sensors 5 during the move of the robot vehicle 1 through the building or the portion of the building 7, as it will be explained later.

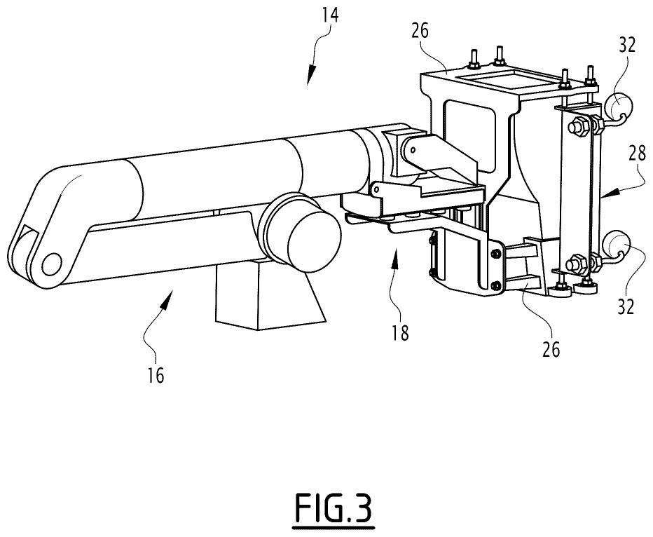

As it can be seen in FIGS. 1 and 3, a sensor support device 26 is fixed to the distal end 18 of the manipulator arm 14. The sensor support device 26 is adapted to be moved towards, in particular against, building surfaces 9, 10, in particular the walls 10 and/or the floor 9 of the building 7, and/or surfaces of the transport object, by the manipulator arm 14.

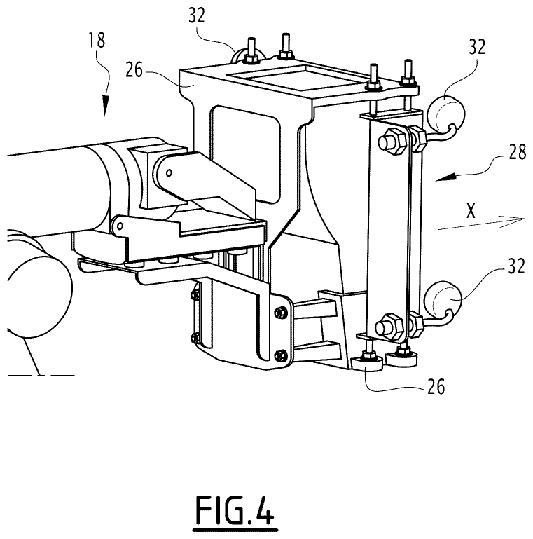

As it is shown in FIGS. 3 to 5, a radiation sensor 28 for measuring radioactive radiation and a spray nozzle 30 are fixed to the sensor support device 26. The radiation measured by the radiation sensor 28 is for example alpha, beta and gamma radiation.

In some embodiments, the radiation sensor 28 is connected to signal processing circuitry (not shown) which is fixed to the body 3 of the robot vehicle. The signal processing circuit is adapted to provide the measured signals to the at least one internal controller 22 and/or the remote controller 20.

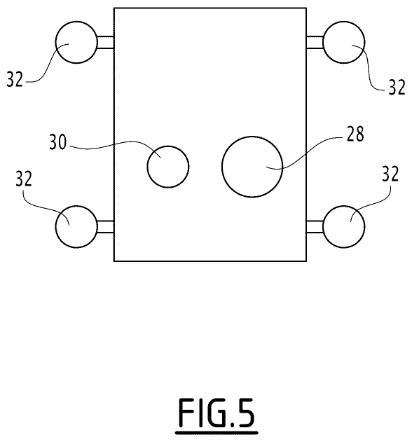

According to embodiments, which may be combined with other embodiments disclosed herein, a plurality of stoppers 32 are fixed to the sensor support device 26. The stoppers 32 are in a fixed relationship with respect to the radiation sensor 28 and/or the spray nozzle 30. The stoppers 32 can be provided, in some embodiments, with a roller or a caster wheel at their distal end. In FIG. 5, four stoppers 32 are shown. However also three or more than four stoppers 32 may be used. The stoppers 32, in particular the distal ends of the stoppers, span a plane, which is in a predetermined distance to the radiation sensor 28. For example, the sensor measurement direction X of the radiation sensor 28 is perpendicular to the plane, which is spanned by the stoppers.

The stoppers 32 are provided on each lateral side of the sensor support device 26, with respect to the measurement direction X of the radiation sensor 28. In some embodiments, the stoppers 32 have a distance of at least 5 cms, in particular of at least 10 cms from each other.

When the sensor support device 26 is pressed by the manipulator arm 14 against a building surface and/or the surface of the transport object, for example the wall 10 or the floor 9, the stoppers 32 abut against the respective surface 9, 10, so that the radiation sensor 28 is in a defined relationship, in particular a predefined distance, with respect to the respective surface 9, 10 to be measured.

Thus, the stoppers 32 form a distance control device that enable the robot vehicle to position the radiation sensor 28 at a predefined distance to the building surface 9, 10.

Alternatively or additionally, at least one distance sensor, in particular contactless or mechanical distance sensors, may be used. The distance sensor may be an inductive, capacitive, laser, microwave or other type of sensor, which can measure a distance of a few centimeters with sub-millimeter accuracy. For example, each distance sensor provides its measurement results to the at least one internal controller 22. In some embodiments, which may be combined with other embodiments disclosed herein, two, three or more distance sensors are used. For example, in such a case, the distance sensors have a distance of at least 5 cms, in particular of at least 10 cms between each other.

Additionally or alternatively to the at least one distance sensors, for estimating the exact distance between the radiation sensor 28 and the respective surface, for example the building surface 9, 10 and/or the surface of the transport object, the at least one internal controller 22 may use information provided from the motors, in particular the one or more joint motors, and/or sensors of the manipulator arm 14, for example manipulator arm calculations and/or operations, in particular in connection with a determined distance between the robot vehicle 1 and the building surface using the plurality of cameras and/or sensors 5.

In operation, the manipulator arm 14 is controlled such the radiation sensor 28 has a predefined distance to the surface to be measured, for example the wall 10 and/or the floor 9. In such a case the at least one distance sensor and/or the at least one internal controller 22, forms the distance control device.

Thus, the distance control device 32 enable the robot vehicle 1 to position the radiation sensor 28 at a predefined distance to the respective surface, for example the building surface 9, 10 and/or the surface of the transport object.

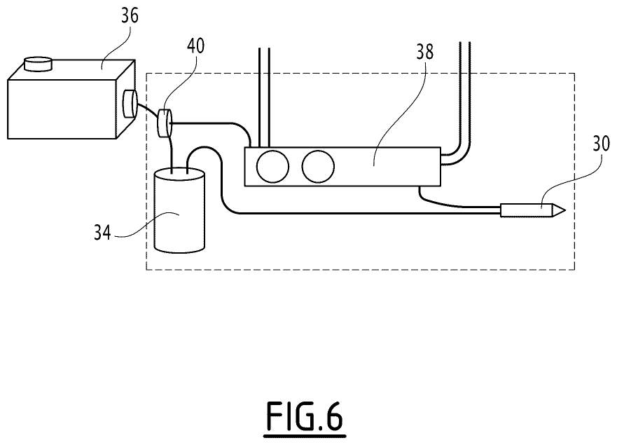

FIG. 6 details a spraying system of the robot vehicle 1. The spray nozzle 30 is connected to a pressurized paint tank 34. The pressurized paint tank 34 is pressurized with pressurized air from a compressed air tank 36. The spray system further includes a spray controller 38, which controls a valve within the spray nozzle 30 and a pressure reducer 40 arranged in a fluid connection between the compressed air tank 36 and the pressurized paint tank 34. With the controllable pressure reducer 40, the pressure of the paint exiting the nozzle can be controlled.

In other words, the spray system is adapted to eject drops of paint against a surface, in particular the building surface 9, 10 and/or the surface of the transport object, for example the wall 10 and/or the floor 9. The number of drops and the speed of the drops can be controlled using the spray controller 38. For example, the speed of the drops is controlled by the pressure in the paint tank 34 and adapted to the distance between the building surface 9, 10 and the spray nozzle 30 and/or the sensor support device 26. The number of drops depends on the speed of the spray nozzle 30 and/or the sensor support device 26 with respect to the building surface 9, 10, in particular in parallel to the respective surface, for example the building surface and/or the surface of the transport object.

Thus, detailed patterns, for example lines, dotes, characters and the like can be sprayed on the surface, for example the wall 10 and/or floor 9, using the manipulator arm 14 provided with the spray nozzle 30.

The spray direction of the spray nozzle 30 is preferably parallel to the measurement direction X of the radiation sensor 28.

The at least one internal controller 22 and/or remote controller 20 are adapted to determine the distance between the spray nozzle 30 and the surface or target building surface 9, 10, in particular based on the plurality of sensors and/or cameras 5 of the robot vehicle 1 and/or sensors in the manipulator arm 14. Depending on the determined distance, the spray controller 38 controls the valve within spray nozzle and/or the pressure in the paint tank 34.

According to embodiments, the paint tank 34, the spray controller 38, the pressure reducer 40 and/or the pressurized air tank 36 are fixed to the body 3 of the robot vehicle 1. Thus, the weight to be moved by the manipulator arm 14 is reduced.

In some embodiments, a sample taking device may be fixed to the manipulator arm 14 in addition or alternatively to the sensor support device 26. For example, the sample taking device may be a chisel for creating a scratch samples and/or a drill bit, wherein the created dust is collected by a collecting device, for example an aspirator. In some embodiments, the sample taking device may include a gripper.

In the following, the functioning of the robot vehicle 1 and of the method according an embodiment will be explained. The method may be performed using the robot vehicle 1 or by the robot vehicle 1. In some embodiments all steps are performed by the at least one internal controller 22 of the robot vehicle, in other embodiments a portion of the steps are performed by the at least one internal controller 22 and another portion of the steps are performed by one or more remote controllers 20. In other words, the method according to embodiments disclosed herein is computer implemented, and in particular executed on one or more controllers, which may be remote to each other.

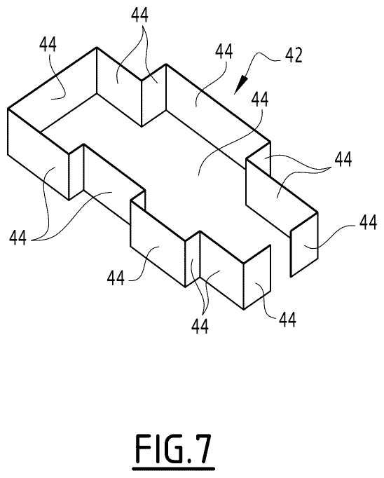

In a first step 1010, the robot vehicle 1 explores at least a portion of the building 7 and scans the building surfaces 9, 10, in particular the floor 9 and/or the walls 10, with the at least one sensor and/or cameras 5. Alternatively or additionally, the robot vehicle 1 explores at least a portion of the transport object and scans the surfaces of the transport object with the at least one sensor and/or cameras 5. For example, the data obtained by the plurality of sensors and/or cameras 5 are then used to generate a 3D map 42 of at least of a portion of the building 7 and/or the transport object. The 3D map 42 includes a plurality of segments 44. Each segment represents flat sections of building surfaces and/or surfaces of the transport object. For example, each segment represents a flat section of the building surfaces 9, 10, in particular the wall 10 and/or the floor 9. FIG. 7 shows such an example of a virtual 3D map 42. In other words, in a first step 1010, the 3D map 42 of the portion of the building 7 is acquired. For example, a SLAM (simultaneous localization and mapping) or CML (concurrent mapping and localization) algorithm may be used for that purpose.

In some embodiments, the robot vehicle 1 can explore the at least one portion of the building 7 and/or the transport object automatically. In other embodiments, an operator guides the robot vehicle 1 through the at least one portion of the building 7 and/or the transport object, for example by using the remote controller 20. For example, a 3D map 42 of one or more rooms is acquired.

According to embodiments, the portion of the building and/or the transport object is explored at least twice. This enables to create a 3D map with a higher precision.

In step 1020, one or more segments 44 of the building 7 and/or of the transport object is segmented to form a grid of sectors, which have preferably the same size. In other words, a grid of sectors 46 is applied to each segment 44. The plurality of sectors 46 are adjacent to each other. In other words, each sector has at least one adjacent sector 46. The segmenting is performed by the system according to an embodiments disclosed herein, in particular by the internal controller 22 and/or the remote controller 20.

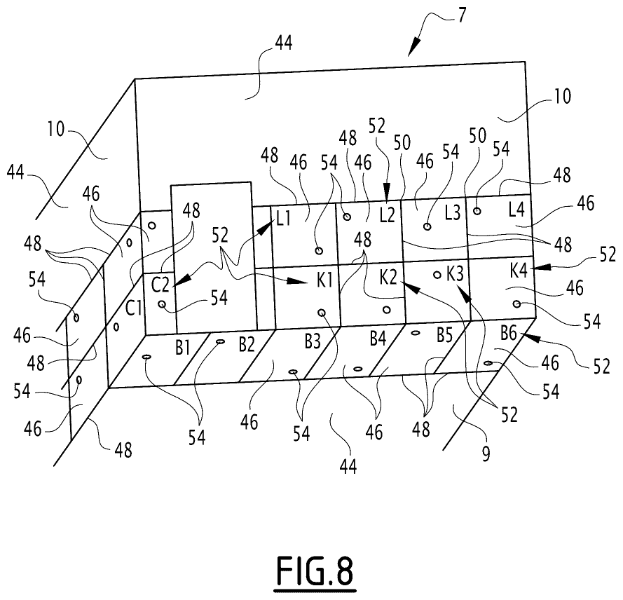

For example, at least two, in particular at least 50% of the sectors 46 have a predetermined size. For example, the predetermined size corresponds to a surface on the wall and/or the floor of between 0.75 m² and 1.5m². In some embodiments, only the sectors at the border of the segments 44 have a smaller size compared to the predetermined size. Typically, the sectors 46 have a regular shape or a rectangular shape. In some embodiments, the sectors 46 of the predetermined size have a square shape. In an embodiment, the square has a size corresponding to 1 m×1 m on the surfaces of the building, here the walls 10 and/or the floor 9. In other embodiments, the sectors 46 may have a hexagonal shape or triangular shape. FIG. 8 shows an example of a building 7, wherein to each segment, here the walls 10 and the floor 9, is applied a grid of sectors 46.

The sectors 46 are also stored in the 3D map 42 of the building 7 and/or of the transport object. For example, the sectors 46 may be stored in the at least one internal controller 22 or the remote controller 20. In an example, the sectors 46 may be digitally or virtually marked in the 3D map 42.

Then, the robot vehicle 1 moves through the building 7 and/or the transport object and physically marks the borders 48 of each sector 46 with the paint on the respective surface. For example, the robot vehicle 1 approaches a surface, for example a building surface 9, 10 and/or a surface of the transport object, and uses the spray nozzle attached to the distal end of the manipulator arm 14 to mark with paint at least the corners 50 of each sector 46. In an example, a “T”-shaped symbol, a “+”-shaped symbol or an “L”-shaped symbol can be used depending on whether there are adjacent sectors or not. In other words, with these symbols, the borders are the sectors 46 are marked physically. In other words, at least a portion of the borders is physically marked. The physical marking is done, such that the complete border can be extrapolated from the physical marking.

In some embodiments, the complete border 48 of the sector 46 is marked with paint on the respective surface, for example the building surface 9, 10 and/or the surface of the transport object. In other words, a continuous line of paint surrounds each sector 46 to form the border 48.

The paint is applied to the building surface 9, 10 and/or on the surface of the transport object, for example the at least one wall 10 and/or the floor 9, such that the marked borders 48 on the building surface 9, 10 and/or on the surface of the transport object corresponds to the borders of the sectors 46 in the 3D map 42.

The marked border 48 of the sectors 46 enable the robot vehicle 1, to identify and locate at a later step each sector 46 with a high precision. For example, the movement of the manipulator arm 14, in particular of the sensor support device 26, is controlled based on the recognition of the marked borders 48 of the sectors 46 on the building surfaces and/or on the surfaces of the transport object.

According to some embodiments, each segment 46 is associated with a unique identifier 52, which is also stored in the 3D map and/or associated with the respective sector 46 in the 3D map 42. The identifier 52 may have one or more characters. In an embodiment, the robot vehicle 1 also physically marks each sector 46 with its identifier 52 using the paint and the spray nozzle 30.

In step 1030, the robot vehicle 1, the remote controller 20, or an operator selects one or more sectors 46 for mapping the radiation of the one or more sectors 46. In some embodiments, all sectors 46 are automatically selected. The robot vehicle 1 moves close to one of the selected sectors 46 and moves the manipulator arm 14, such that the radiation sensor 28 has a predefined distance to the surface of said sector 46.

For example, when using the stoppers 32, the manipulator arm 14 is moved towards the building surface 9, 10 of the sector and/or towards the surface of the transport object of the sector, until each stopper 32 touches that surface. This can be for example detected by determining the force applied to each joint motor of the manipulator arm 14.

According to embodiments, the robot vehicle 1 uses the marked borders 48 of the sectors 46 to precisely navigate through the portion of the building 7 and/or to precisely move the manipulator arm 14, in particular for measuring the radiation using the radiation sensor 28, as explained here-below. Accordingly, the robot vehicle 1 can navigate precisely through the portion of the transport object.

Then, in step 1040, the manipulator arm 14 moves the radiation sensor 28 along the complete surface of the respective sector 46 and the measured radiation values are recorded by the at least one internal controller 22 and/or the remote controller 20. In other words, the complete surface of the respective sector 46 is scanned with the radiation sensor 28. During that time, the stoppers 32 remain on the surface of the respective sector 46, such that the radiation sensor 28 has always the same distance to the surface of the sector 46 under inspection. In case distance sensors are used, the movement of the manipulator arm 14 is controlled, such that the distance between the radiation sensor 38 and the surface of the sector 46 remains substantially constant.

For example, the robot vehicle 1 is adapted to acquiring at least one image of a surface 9, 10, for example the building surface or surface of the transport object, to determine the borders 48 of sectors 46 on the surface 9, 10 based on the acquired image and to move the robot vehicle 1 and/or a manipulator arm 14 of the robot vehicle 1 based on the determined borders 48 during a scanning with the radiation sensor 28. For example, the plurality of sensors and/or cameras 5 may be used for acquiring the at least one image of the respective surface, for example the building surface or surface of the transport object. The image may be an image including depth information, for example an RGB-D image. The at least one internal controller 22 and/or remote controller 20 may than use one or more image recognition algorithms in order to determine the borders 48 of the sectors and their position on the surface 9, 10, for example the building surface or surface of the transport object, and/or with respect to the robot vehicle 1.

In some embodiments, which may be combined with other embodiments disclosed herein, the measured radioactive radiation is displayed on the 3D map 42, for example using a color code.

In step 1050, after the complete sector 46 has been scanned with the radiation sensor 28, a point 54 within the sector 46 with the highest measured radiation is determined. Then, the robot vehicle 1 is instructed to mark that point 54 with paint, in particular by using the spray controller 38 and the spray nozzle 30. For example, the point 54 may be marked with a dot, a rectangle, in particular defining the borders of the radiation measurement of the radiation sensor 28. In other words, for each sector 46 the point 54 with the highest measured radiation is physically marked. Optionally, in some embodiments, the point 54 is virtually marked in the 3D map 42.

In an optional step, if the manipulator arm 14 is provided with the sample taking device, for example at the point 54 with the highest radiation a sample is taken.

In some embodiments, if the measurement of the radiation of the sector 46 is finalized, the robot vehicle 1 may mark that it has finished that sector. This may facilitate a later control by a human and/or a human/machine cooperative work.

According to the present disclosure, the radiation measurements of the robot vehicle 1 can be manually confirmed. Thus, the radiation measurements realized by the robot vehicle can be used for a clearance measurement of portions of the building 7 and/or of the transport object. In other words, the radiation measurements may be used for confirming that the remaining radioactive radiation does not exceed a predetermined level, in particular before the building and/or transport object is destroyed or otherwise used.

According to the present disclosure, the radioactive dose to persons performing the measurements is reduced. Further, the time for performing the measurements can be reduced using the robot vehicle 1. Further, the accuracy is increased as the robot vehicle may use the marking on the building surfaces for the orientation.

According to some embodiments, the 3D map with the associated results of the radiation measurements can be used for a prediction of radioactive contamination.

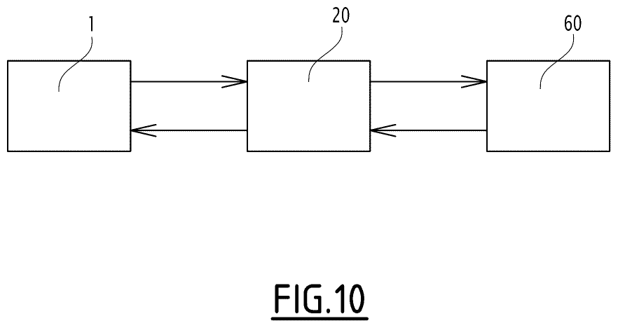

FIG. 10 discloses a system for mapping automatically the radiation in a portion of a building and/or transport object with the robot vehicle 1. The robot vehicle is adapted to transmit a 3D map and/or the sensor data to the remote controller 20. For example, the sensor data are obtained from the plurality of cameras and/or sensors 5. For example, in case of a LIDAR, the sensor data correspond to a cloud of points, also called Point Cloud (PC). In an embodiment, the point cloud does not include visible light, for example color, or texture information. The 3D map of at least one portion of the building 7 and/or of the transport object is generated in the robot vehicle, for example the internal controller 22, or by the remote controller 20.

According to an embodiment, which may be combined with other embodiments disclosed herein, the remote controller 20 is located in a non contaminated location, for example in another portion of the building or another building.

As described above, a 3D map 42 is generated, wherein the 3D map 42 comprises a plurality of segments 44, each representing an in particular substantially flat section of the building surface 9, 10 and/or of the surface of the transport object. For example, the cloud of points is used to generate the flat segments 44 of the 3D map 42. In case the 3D map 42 is generated by the internal controller 22 or the robot vehicle, it is sent to the remote controller 20. In case the 3D map 42 is generated by the remote controller 20, it may be sent to the robot vehicle. In other words, the 3D map 42 is acquired.

According to embodiments, the 3D map 42 is enhanced with images acquired by the camera 5. The images are taken for example with visible wavelengths for humans. In other words, the images are integrated or merged into the 3D map 42 in order to improve the visible perception for a human. For example, each point in the point cloud and/or the segments 44 of the 3D map is colored using the visible light information or color information from the images acquired by the camera 5. For example, the point clouds and/or the segments 44 have then the correct visible light information in the 3D map. In an embodiment, the segments 44 the 3D map 42 are visualized in a transparent manner. In such a case, the point of clouds still represents the total 3D map.

The remote controller 20 is further adapted to rendering a 3D image based on a portion of the 3D map 42. Rendering is a generation of an image by taken the information from the 3D map and using the geometry, lighting and texture or other information to create a visual representation of the 3D map. For example, a virtual camera inside the 3D map defines position, orientation and the field of view of the point of view from which a scene to be created is rendered. The rendered 3D image may be enhanced with further information, for example the measured radiation or the size of the room and/or the images taken by the camera 5. Alternatively or additionally, the rendered 3D image may be enhanced with no go areas for persons operators, information on recognized objects (which are for example recognized by machine learning algorithms), tags or notes on objects, and/or data from existing BIM (Building Information Modelling). The virtual camera of rendered 3D image can be positioned at a desired point within the 3D map 42. For example, the virtual camera may be positioned above the robot vehicle, on the manipulator arm, on the body of the robot vehicle or the like. According to embodiments, the rendered 3D image is a stereo image.

The remote controller 20 is then adapted to send the rendered 3D image to at least one virtual reality system 60. The virtual reality system 60 is adapted to show the 3D image to at least one person, for example the operator.

According to an embodiment, which may be combined with other embodiments disclosed herein, the virtual reality system 60 is located in a non-contaminated location, for example in another portion of the building or in another building, whereas the robot vehicle 1 is located in a potentially contaminated portion of the building. Contaminated means that the portion of the building is radioactively contaminated.

In particular, the virtual reality system 60 is located remotely from the robot vehicle 1.

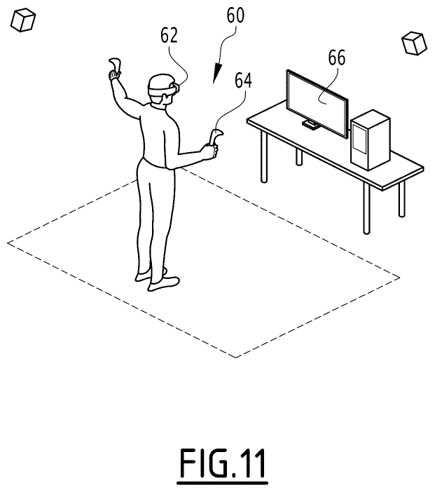

FIG. 11 shows an embodiment of the virtual reality system 60. The virtual reality system comprises a goggle 62 or glasses in which the 3D image is shown on at least one screen. Thus, a person can have a 3D impression of the room, where the robot vehicle 1 is present. Alternatively or additionally, the (rendered) 3D image may be shown on at least one monitor or at least one screen 66. Alternatively, a video projector may be used.

In some embodiments, the 3D image shown to the person may depend also on the orientation of the goggle and/or the movement, in particular of the head, of the person. Thus, the person wearing of the goggle 62 has the perception if he would be in the portion of the building where the robot vehicle is present. Further, the person is adapted to walk virtually through the portion of the building where the robot is present. For that purpose, the goggle or the glasses may include sensors in order to detect the position of the goggle. Further, a location or room, where the virtual reality system 60 is installed may include sensors, in order to detect the movement of the person. In other words, the position and orientation of the virtual camera for rendering the 3D image depends on the orientation and position of the goggle and/or the person.

The virtual reality system 60 comprises further at least one commanding device 64. Thus, the commanding device is also arranged remotely from the robot vehicle. The commanding device 64 is located in a non-contaminated location, for example in another portion of the building or in another building, whereas the robot vehicle 1 is located in a potentially contaminated portion of the building.

For example, the commanding device 64 may be a handheld device. The commanding device 64 may sense its orientation and or position within the room. In other embodiments, the position or orientation of the commanding device 64 is sensed by stationary sensing equipment.

In some embodiments, the commanding device 64 may include buttons. The commanding device is located at the same location as the at least one screen 62, 66. For example, the person may command the manipulator arm 14 with the commanding device 64. In an embodiment, the person can take control of the robot vehicle 1 and the manipulator arm 14 with the sensor support device 28 and/or with another device or tool mounted to the manipulator arm 14, for example the sample taking device, in order to perform special tasks (e.g. handle complex objects, make special observations, which are not on the autonomous stack of the robot vehicle 1. In some embodiments, the measurement tasks for radiological measurements are completely autonomous and only just the first visit by the robot vehicle to the unknown building sections or transport device sections may be guided by a person or operator and/or the definition of the jobs or tasks may be done by the person or operator. In an embodiment, the job or task creation must be initialized by a person or operator.

In other embodiments, which may be combined with any embodiments disclosed herein, the stationary sensing equipment may sense the position and the gesture of the person or portions of the person, for example the head and/or the hands of the person. Then, the person or operator corresponds to the commanding device.

In response to a movement of the commanding device and/or the actuating of a button, commands the commanding device 64 is adapted to send commands to the remote controller 20. The remote controller 20 then transmits the received commands from the commanding device 64 to the robot vehicle 1. Upon reception of the command, the robot vehicle 1 operates in response to the received command. For example, the manipulator arm and/or the sensor support device 28 may be moved in response of the received command.

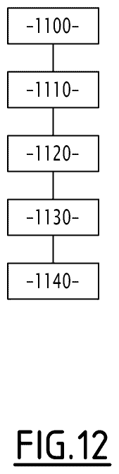

FIG. 12 shows a flow chart of an embodiment of a method according to the present disclosure. In a first step 1100, a 3D map 42 of a portion of a building 7 and/or of a transport object, wherein the 3D map 42 comprises a plurality of segments 44, each representing a substantially flat building surface.

In a next step 1110 to each segment, a plurality sectors forming a grid of sectors is applied. Each sector has a border 48. Further, the robot vehicle 1 physically marks the border of each sector with paint on the corresponding building surface and/or surface of a transport object.

The, in step 1120, the radiation for one or more sectors, by scanning, by the robot vehicle, with a radiation sensor each sector is mapped, in particular automatically mapped, to measure the radioactive radiation within that sector.

Then, in step 1130, at least one 3D image based on at least one portion of the 3D map is rendered and sent to at least one screen being arranged remotely from the robot vehicle 1. Remotely means that the screen, for example of the virtual reality system 60, is located in a non-contaminated location, for example in another portion of the building or in another building, whereas the robot vehicle 1 is located in a potentially contaminated portion of the building.

In step 1140, a command is detected, for example by the remote controller 20, from the commanding device 64 of the virtual reality system 60 and transmitted to the robot vehicle 1. For example, the commanding device is adapted to send its position, orientation or activation of a button to the remote controller 20. Alternatively or additionally, a stationary sensing equipment sends the position and/or orientation of the commanding device 64 to the remote controller 20. Then the robot vehicle 1, in particular the manipulator arm 14, operates in response to the commands. This facilitates the control of the robot vehicle if required, as the robot vehicle is controlled by the body movement.

The present disclosure relates to a robot configured for automatically mapping the radiation in a building, in particular in a building of nuclear power plant and/or of a transport object. This robot comprises the plurality of sensors and cameras, configured for acquiring a 3D map of the area and a radiation sensor, configured for measuring the radiation throughout the considered area, and a computation device, configured for displaying the radiation measurements on the 3D map so as to obtain a 3D cartography of the radiation levels in the considered area.

### LIST OF REFERENCE SIGNS

1 robot vehicle
3 main body
5 cameras and/or sensors
7 building
9 surface of building, floor
10 surface of building, wall
12 movement apparatus
14 manipulator arm
16 proximal end
18 distal end
20 remote controller
22 internal controller
24 communication device
26 sensor support device
28 radiation sensor
30 spray nozzle
32 stoppers
34 paint tank
36 air tank
38 spray controller
40 pressure reducer
42 3D map
44 segment
46 sector
48 border
50 corner
52 identifier
54 point
60 virtual reality system
62 goggle
64 commanding device
66 screen
X measurement direction

What is claimed is:

1-30. (canceled)

31. A method for automatically mapping radiation in a portion of a building and/or of a portion of a transport object using a robot vehicle, the portion of the building and/or of the transport object comprising a plurality of surfaces, the method comprising:
acquiring a 3D map of the portion of the building and/or of the portion of the transport object, wherein the 3D map comprises a plurality of segments, each segment representing a corresponding surface of the building and/or of the transport object;
applying to each segment a plurality sectors forming a grid of sectors, each sector having a border;
physically marking, by the robot vehicle, at least a portion of the border of each sector with paint on the corresponding surface;
mapping the radiation for one or more sectors, by scanning, by the robot vehicle, with a radiation sensor each sector of the one or more sectors, to measure the radiation within that sector;
rendering at least one 3D image based on at least one portion of the 3D map;
sending the at least one rendered 3D image to at least one screen of a virtual reality system being arranged remotely from the robot vehicle;
detecting commands from a commanding device of the virtual reality system;
transmitting the commands to the robot vehicle; and
operating the robot vehicle in response to the commands.

32. The method as recited in claim 31, wherein the at least one screen is in a goggle or projected in a goggle.

33. The method as recited in claim 31, wherein the robot vehicle comprises the radiation sensor for measuring radioactive radiation and at least one camera and/or one or more second sensors, the one or more second sensors being adapted to provide data that enables determining a position of the robot vehicle within the building and/or determining a distance to objects within the building, wherein acquiring the 3D map of the portion of the building comprises:
acquiring data from the plurality of cameras and/or second sensors; and
generating the 3D map of the portion of the building from the acquired data.

34. The method as recited in claim 33, wherein the at least one 3D image acquired by the at least one camera is integrated in the 3D map.

35. The method as recited in claim 34, wherein the at least one 3D image acquired by the at least one camera is integrated in the 3D map by coloring segments of the 3D map and/or each point in a point cloud used for generating the segments using visible light information or color information from the at least one 3D image acquired by the at least one camera.

36. The method as recited in claim 31, wherein the robot vehicle comprises a manipulator arm having a proximal end fixed to a main body of the robot vehicle and a distal end, wherein a sensor support device is fixed to the distal end of the manipulator arm, the radiation sensor for measuring radioactive radiation being fixed to the sensor support device.

37. The method as recited in claim 36, further comprising operating the manipulator arm of the robot vehicle in response to the commands.

38. The method as recited in claim 31, further comprising acquiring by the robot vehicle at least one image of the surface, determining the borders of the sectors on the surface based on the acquired at least one image, and moving the robot vehicle and/or a manipulator arm of the robot vehicle based on the determined borders during scanning with the radiation sensor.

39. The method as recited in claim 31, further comprising for one or more of the sectors, scanning, by the robot vehicle, with a radiation sensor each sector, to measure the radioactive radiation within that sector.

40. The method as recited in claim 31, wherein the radiation for one or more of the sectors is automatically mapped.

41. The method as recited in claim 31 further comprising digitally marking the grid of sectors in the 3D map.

42. The method as recited in claim 31 further comprising displaying the measured radioactive radiation on the 3D map.

43. The method as recited in claim 31, wherein the physically marking is performed by spraying paint on the surface.

44. A system comprising:
a robot vehicle for automatically mapping radiation in a portion of a building and/or of a portion of a transport object, the portion of the building and/or the transport object comprising a plurality of surfaces, the robot vehicle comprising:
a main body;
a movement apparatus adapted to move the robot vehicle over a rough surface comprising steps;
a radiation sensor for measuring radioactive radiation; and
a spray nozzle;
wherein the system further comprises a remote controller and a commanding device arranged remotely from the robot vehicle, wherein the remote controller and/or the robot vehicle is adapted to acquire a 3D map of a portion of the building, wherein the 3D map comprises a plurality of segments, each representing a corresponding surface of the building and/or the transport object;
wherein the system is adapted to apply to each segment a plurality sectors forming a grid of sectors, each sector having a border;
wherein the robot vehicle is adapted to physically mark at least a portion of the border of each sector with paint on the corresponding surface;
characterized in that the remote controller is adapted to render a 3D image based on a portion of the 3D map to be displayed on at least one screen and to send the rendered 3D image to the at least one screen;
wherein the commanding device is adapted to send commands to the remote controller,
wherein the remote controller is adapted to transmit the commands to the robot vehicle,
wherein the robot vehicle is adapted to operate in response to the commands.

45. The system as recited in claim 44, wherein the robot vehicle further comprises a plurality of cameras and/or one or more second sensors, the one or more second sensors are adapted to provide data that enables to determine a position of the robot vehicle within the building and/or to determine a distance to objects within the building, wherein the remote controller and/or an internal controller of the robot vehicle is adapted to acquire the data from the plurality of cameras and/or second sensors and to generate the 3D map of the portion of the building based on the acquired data.

46. The system as recited in claim 44, wherein the commanding device is a handheld device or an operator.

47. The system as recited in claim 44, wherein the robot vehicle comprises at least one distance control device adapted to control the distance between the radiation sensor and the surface to be measured.

48. The system as recited in claim 47, wherein the distance control device comprises at least three stoppers being in a fixed relationship with respect to the radiation sensor and/or the spray nozzle, distal ends of the at least three stoppers spanning a plane, the plane being is in a predetermined distance to the radiation sensor.

49. The system as recited in claim 47, wherein the distance control device comprises at least one distance sensor at a sensor support device and/or at least one internal controller adapted to estimate the distance between the radiation sensor and the surface based on data of one or more joint motors and/or sensors of a manipulator arm in connection with a determined distance between the robot vehicle and the surface using a plurality of cameras and/or second sensors.

50. The system as recited in claim 44, wherein the robot vehicle is adapted to acquire at least one image of a surface by a plurality of cameras and/or second sensors, to determine the borders of sectors on the surface based on the acquired image, and to move the robot vehicle and/or the manipulator arm of the robot vehicle based on the determined borders during a scanning with the radiation sensor.
